(19) United States
(12) Patent Application Publication
(10) Pub. No.: US 2022/0222621 A1
(43) Pub. Date: Jul. 14, 2022

(54) DELIVERY SYSTEM

(71) Applicant: TOYOTA JIDOSHA KABUSHIKI KAISHA, Aichi-ken (JP)

(72) Inventors: Tetsuya KANATA, Toyota-shi (JP); Masao TAJIMA, Toyota-shi (JP); Takashi HAYASHI, Toyota-shi (JP); Nobuyuki TOMATSU, Nagoya-shi (JP); Hideki FUKUDOME, Nisshin-shi (JP); Takashi HAYASHI, Nagoya-shi (JP); Yoshiumi KAWAMURA, Nisshin-shi (JP); Kosuke AKATSUKA, Mishima-shi (JP); Manabu YAMAMOTO, Toyota-shi (JP); Kosuke SAKAKIBARA, Toyota-shi (JP)

(21) Appl. No.: 17/558,601

(22) Filed: Dec. 22, 2021

(30) Foreign Application Priority Data
Jan. 8, 2021 (JP) 2021-002213

(51) Int. Cl. G06Q 10/08; G06Q 10/06

(52) U.S. Cl. CPC G06Q 10/0834; G06Q 10/063112; G06Q 10/08355; G06Q 10/0832

(57) ABSTRACT

A package selection section selects a package for delivery based on package information obtained by a package information section, taking into consideration suitability (attributes) of a delivery driver based on driver information obtained by a driver information section. A route generation section then generates a delivery route for the delivery driver to deliver to a delivery destination.

### CROSS-REFERENCE TO RELATED APPLICATION

This application is based on and claims priority under 35 USC § 119 from Japanese Patent Application No. 2021-002213 filed on Jan. 8, 2021, the disclosure of which is incorporated by reference herein.

### TECHNICAL FIELD

The present disclosure relates to a delivery system.

### RELATED ART

Japanese Patent Application Laid-Open (JP-A) No. 2006-240794 (Patent Document 1) discloses delivery schedule creation technology in which, after a truck (delivery vehicle) has left a logistics center (dispatch base), the truck stops by another logistics center to load on packages in order to perform efficient transportation (hereafter referred to as delivery).

Staff shortages have become a serious issue in the logistics industry in recent years, and it is therefore important to both secure and retain delivery drivers. On the other hand, age, gender, physical build, and so on differ between each individual delivery driver, resulting in differences in delivery ability between delivery drivers. Thus, even if delivery can be performed efficiently by using the delivery schedule of the above background art, each individual delivery driver will still experience a different burden if allocated a uniform delivery quota.

In consideration of the above circumstances, the present disclosure provides a delivery system that is capable of lightening the burden experienced by individual delivery drivers, and that enables packages to be delivered efficiently.

### SUMMARY

A delivery system according to a first aspect includes a package information section configured to collect package information indicating respective types of plural packages for delivery from a dispatch base, a driver information section configured to collect driver information indicating suitability of each of plural delivery drivers to delivery of the respective packages from the dispatch base to a delivery destination, a package selection section configured to select a package for delivery by a delivery driver based on the package information obtained by the package information section and the driver information obtained by the driver information section, and a delivery route generation section configured to generate a delivery route for a delivery driver to deliver a package selected by the package selection section to the corresponding delivery destination.

The delivery system according to the first aspect includes the package information section, the driver information section, the package selection section, and the delivery route generation section.

The package information section collects the package information indicating the respective types of the plural packages for delivery from the dispatch base. The package information may include package weights, package contents (ambient temperature, frozen, or chilled), and delivery destination addresses indicating where the packages are to be delivered.

The driver information section collects the driver information indicating the suitability of each of the plural delivery drivers to delivery of the respective packages from the dispatch base to the corresponding delivery destination. The driver information may include maximum deliverable weights, driving skill, nationality, gender, and unfeasible delivery information (for example stairs) regarding deliveries that would place a high load on the delivery driver and are unable to be performed (delivery exemptions).

The package selection section selects a package for delivery by a delivery driver based on the package information obtained by the package information section and the driver information obtained by the driver information section. The delivery route generation section then uses map information to generate a delivery route for the delivery driver to deliver the package selected by the package selection section to the corresponding delivery destination.

As described above, in the present disclosure, the package selection section selects packages for delivery based on the package information obtained by the package information section in consideration of the suitability (attributes) of each delivery driver according to the driver information. This enables the burden experienced by each individual delivery driver to be lightened.

Moreover, the delivery route generation section generates the delivery route for the delivery driver to deliver to the corresponding delivery destination. This enables efficient delivery of packages based on the delivery route without the delivery driver having to devise the delivery routes themselves.

A delivery system according to a second aspect is the delivery system according to the first aspect, wherein the package information is information including a package weight, and the driver information is information including a maximum deliverable package weight of each of the delivery drivers.

In the delivery system according to the second aspect, the package information is information including the package weight, and the driver information is information including a maximum deliverable package weight of each of the delivery drivers. Accordingly, the package selection section selects a package for delivery by a delivery driver based on the package weight.

For example, in a case in which a given delivery driver has a maximum deliverable package weight of 3 kg, this delivery driver is also able to deliver packages weighing 2 kg. However, since a package weighing 5 kg would place a high load on this delivery driver, the delivery driver is exempted from delivering such packages. Namely, in the present aspect the package for delivery is selected in consideration of the suitability of the delivery driver.

A delivery system according to a third aspect is the delivery system according to the first aspect or the second aspect, wherein in cases in which the driver information includes first unfeasible delivery information pertaining to the package information as unfeasible delivery information regarding a delivery that would place a high load on the corresponding delivery driver, the package selection section eliminates any package corresponding to the first unfeasible delivery information from being selected for the delivery driver with the first unfeasible delivery information.

In the delivery system according to the third aspect, the driver information is unfeasible delivery information regarding a delivery that would place a high load on the corresponding delivery driver, and the first unfeasible delivery information is information pertaining to the package information. For example, in the case of a delivery driver with a maximum deliverable package weight of 3 kg as described above, it would be difficult to deliver a package weighing 5 kg, and this would place a high load on the delivery driver. Thus, packages weighing more than 3 kg are included in the first unfeasible delivery information for this delivery driver.

The package selection section eliminates any package corresponding to the first unfeasible delivery information from being selected for the delivery driver with the first unfeasible delivery information. Namely, the delivery driver mentioned above would not be expected to deliver excessively heavy packages weighing over 3 kg.

A delivery system according to a fourth aspect is the delivery system according to any one of the first aspect to the third aspect, wherein the delivery route includes impediment information regarding an impediment to package delivery.

In the delivery system according to the fourth aspect, the delivery route includes the impediment information regarding an impediment to package delivery. For example, the impediment information may include information of potential impediments that could place a high load on a delivery driver, such as stairs, narrow roads, and mountain roads. Namely, in the present aspect, the delivery route for delivering a package to a delivery destination is capable of reflecting the impediment information regarding impediments to the delivery driver.

A delivery system according to a fifth aspect is the delivery system according to the fourth aspect, wherein in cases in which the driver information includes second unfeasible delivery information pertaining to the impediment information as unfeasible delivery information regarding a delivery that would place a high load on the corresponding delivery driver, the package selection section eliminates any package corresponding to the second unfeasible delivery information from being selected for the delivery driver with the second unfeasible delivery information.

In the delivery system according to the fifth aspect, the driver information is unfeasible delivery information regarding a delivery that would place a high load on the corresponding delivery driver, and the second unfeasible delivery information is information pertaining to the impediment information. For example, as described previously, stairs, narrow roads, and mountain roads are examples of the impediment information, and driving on a delivery route including such impediments would place a high load on a delivery driver who is unable to make or would not be comfortable making deliveries involving stairs, narrow roads, mountain roads, or the like. Thus, information indicating stairs, narrow roads, mountain roads, or the like is included as the impediment information in the second unfeasible delivery information.

The package selection section eliminates any package corresponding to the second unfeasible delivery information from being selected for the delivery driver with the second unfeasible delivery information. Namely, the delivery driver mentioned above would not be expected to deliver packages to delivery destinations on a delivery route for which they are exempt from or would not be comfortable making deliveries, for example a delivery route involving stairs, narrow roads, mountain roads, or the like.

As described above, the delivery system according to the first aspect is capable of capable of lightening a burden experienced by individual delivery drivers, and enables packages to be delivered efficiently.

The delivery system according to the second aspect is capable of selecting a package for delivery in consideration of the suitability of the delivery driver.

In the delivery system according to the third aspect, the delivery driver is not required to deliver excessively heavy packages in cases in which this would place a high load on the delivery driver, thereby enabling the load on the delivery driver to be lightened.

The delivery system according to the fourth aspect reflects the impediment information regarding impediments to the delivery driver on the delivery route, enabling delivery routes that would present an impediment to the delivery driver to be avoided.

In the delivery system according to the fifth aspect, the delivery driver is not required to deliver packages on delivery routes that would place a high load on that delivery driver, thereby enabling the load on the delivery driver to be lightened.

### BRIEF DESCRIPTION OF THE DRAWINGS

FIG. 1 is a configuration diagram illustrating a configuration of a delivery system according to an exemplary embodiment;

FIG. 2 is a block diagram illustrating a hardware configuration of a server at a dispatch center configuring part of a delivery system according to the present exemplary embodiment;

FIG. 3 is a block diagram illustrating a functional configuration of a server at a dispatch center configuring part of a delivery system according to the present exemplary embodiment;

FIG. 4 illustrates package information employed in a delivery system according to the present exemplary embodiment;

FIG. 5 illustrates driver information employed in a delivery system according to the present exemplary embodiment;

FIG. 6 is a flowchart illustrating an example of a flow of processing by part of a delivery system according to the present exemplary embodiment;

FIG. 7 is a table illustrating which delivery drivers are to deliver packages, as decided by a delivery system according to the present exemplary embodiment;

FIG. 8 is a schematic diagram illustrating a map of a delivery area;

FIG. 9 is a map illustrating a delivery route A of a delivery driver A, as decided by a delivery system according to the present exemplary embodiment; and

FIG. 10 is a map illustrating a delivery route B of a delivery driver B, as decided by a delivery system according to the present exemplary embodiment.

### DETAILED DESCRIPTION

Explanation follows regarding a delivery system according to an exemplary embodiment of the present disclosure, with reference to the drawings.

### Outline of Delivery System

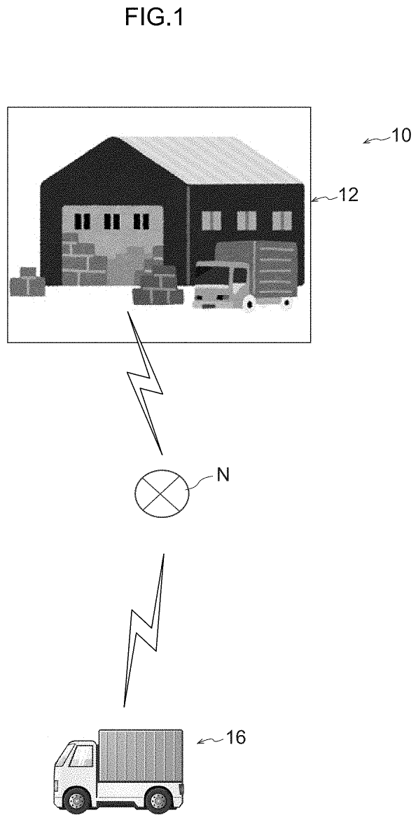

As illustrated in the example of FIG. 1, in a delivery system 10 according to the present exemplary embodiment, a server 14 at a dispatch center 12 configuring a dispatch base from which packages are dispatched for delivery, and a delivery vehicle 16 used to deliver packages are capable of communicating with each other over a network N.

Hardware Configuration of Server

Explanation follows regarding a hardware configuration included in the server 14.

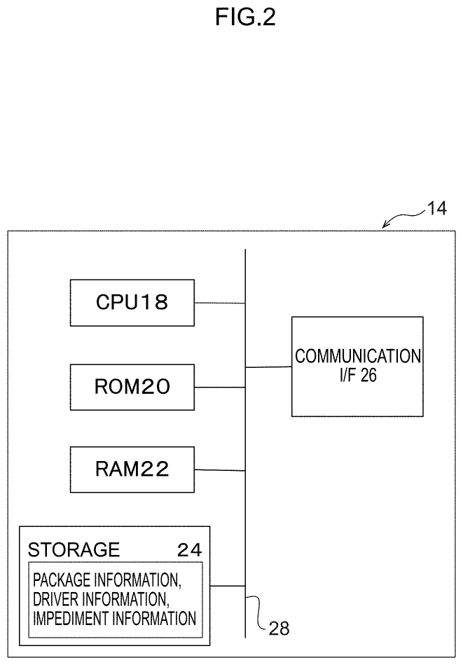

As illustrated in FIG. 2, the server 14 is configured including a central processing unit (CPU) 18, read only memory (ROM) 20, random access memory (RAM) 22, storage 24, and a communication interface (I/F) 26. The CPU 18, the ROM 20, the RAM 22, and the communication interface 26 are connected so as to be capable of communicating with each other through a bus 28.

The CPU 18 is a central processing unit that executes various programs and controls various sections. Namely, the CPU 18 reads a program from the ROM 20 or the storage 24, and executes the program using the RAM 22 as a workspace. The CPU 18 controls the respective configurations and performs various arithmetic processing according to programs recorded in the ROM 20 or the storage 24.

The ROM 20 holds various programs and various data. The RAM 22 acts as a workspace to temporarily store programs or data. The storage 24 serves as a storage section, is configured by a hard disk drive (HDD) or a solid state drive (SSD), and holds various programs including an operating system, as well as various data.

In the present exemplary embodiment, package information relating to packages for delivery, driver information relating to delivery drivers, and impediment information based on a map of a delivery area for the dispatch center 12 (the respective information is described in detail later) are held in the storage 24.

The communication interface 26 is an interface for communicating with other devices such as the delivery vehicle 16 illustrated in FIG. 1. A communication protocol such as Ethernet (registered trademark), LTE, FDDI, or Wi-Fi (registered trademark) may be employed therefor.

Functional Configuration of Server

Next, explanation follows regarding an example of a functional configuration of the CPU 18 of the server 14.

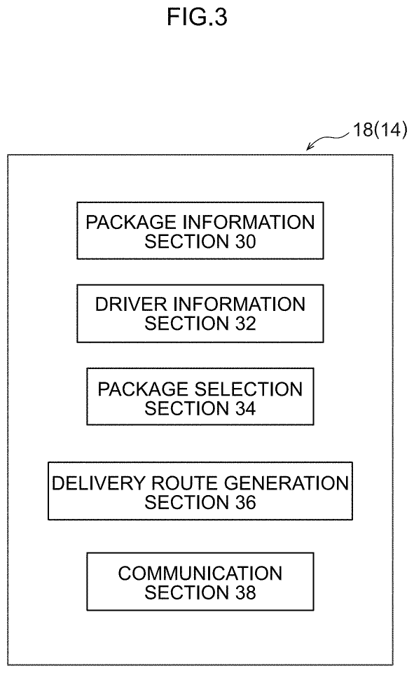

As illustrated in FIG. 3, the CPU 18 includes a package information section 30, a driver information section 32, a package selection section 34, a delivery route generation section 36, and a communication section 38. The respective functional configuration is implemented by the CPU 18 reading and executing an execution program stored in the ROM 20 or the storage 24 illustrated in FIG. 2.

Package information regarding plural packages for dispatch from the dispatch center 12 is collected in the package information section 30. This package information may include package weights, package contents (ambient temperature, frozen, or chilled), and delivery destination addresses indicating where the packages are to be delivered.

Driver information indicating the suitability of plural delivery drivers for delivery of respective packages from the dispatch center 12 to their delivery destinations is collected in the driver information section 32. This driver information may include maximum deliverable weights, driving skill, nationality, gender, unfeasible delivery information regarding deliveries that would place a high load on the delivery driver and is unable to be performed (impediment information regarding stairs, etc.), working hours, and delivery volumes.

The package selection section 34 selects packages for delivery by a delivery driver based on the package information obtained by the package information section 30 and the driver information obtained by the driver information section 32. Namely, in the present exemplary embodiment, packages are selected for delivery in accordance with the driver information (described in detail later).

The delivery route generation section 36 uses map information to generate delivery routes for the delivery drivers to deliver the packages selected by the package selection section 34 to their delivery destinations. Note that the delivery route includes the impediment information. The impediment information may include information regarding stairs, narrow roads, and the like. Note that this impediment information is automatically derived based on the delivery destination address where the corresponding package is to be delivered.

Note that in the present exemplary embodiment, the delivery route is modified based on the driver information held in the storage 24. Namely, in the present exemplary embodiment, the delivery route is generated in accordance with the driver information (described in detail later).

The communication section 38 transmits information regarding a delivery route generated by the delivery route generation section 36 to the corresponding delivery vehicle 16.

Operation and Advantageous Effects of Delivery System

First, explanation follows regarding specific examples of the package information and driver information.

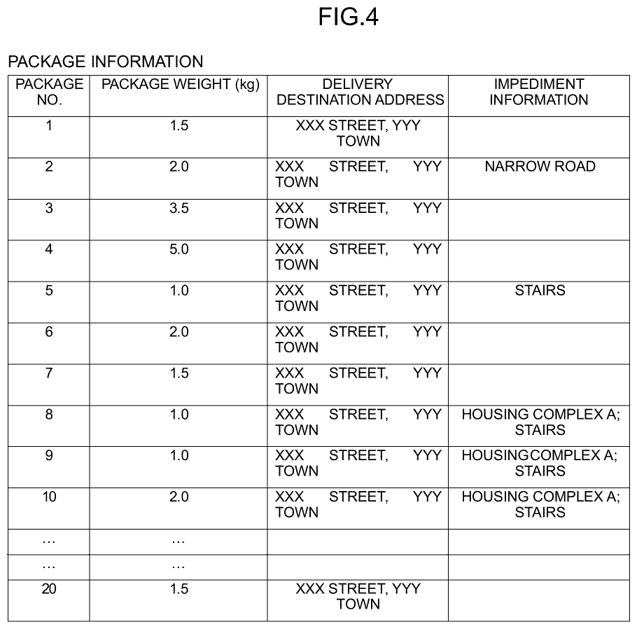

FIG. 4 illustrates package information. For example, the package information includes information indicating a package weight, delivery destination address, and impediment information for respective packages.

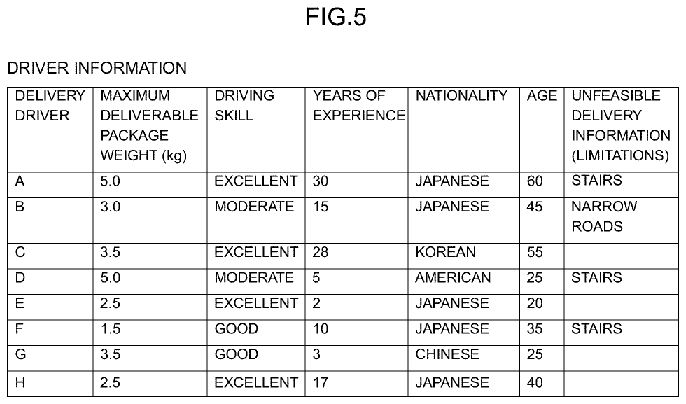

FIG. 5 illustrates driver information. For example, the driver information includes information indicating a maximum deliverable package weight, driving skill, years of experience, nationality, age, and unfeasible delivery information (limitations) for each delivery driver.

In the present exemplary embodiment, the package selection section 34 selects packages for delivery by a delivery driver based on this information.

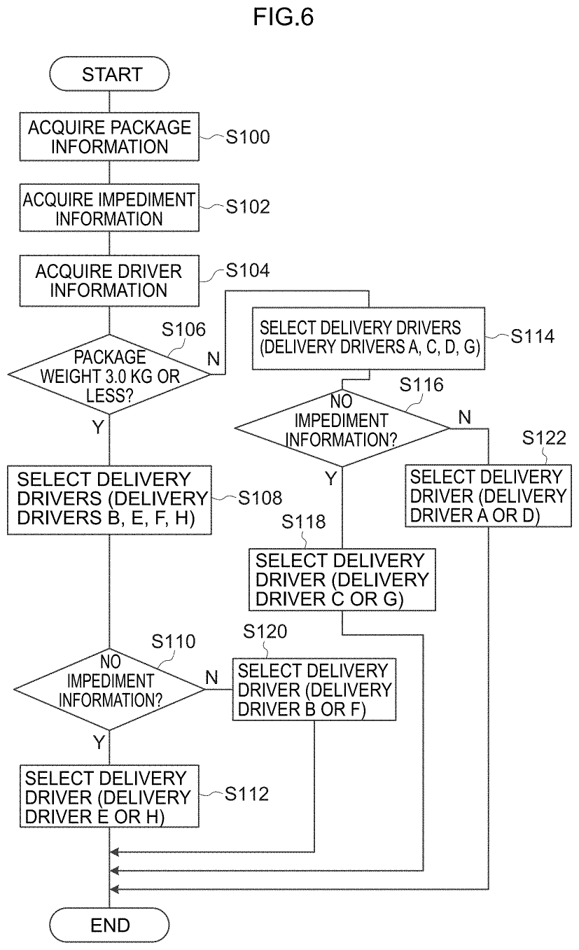

Explanation follows regarding an example of a flow of processing performed by the package selection section 34 to select packages for delivery by a delivery driver, based on the flowchart illustrated in FIG. 6 and with reference to FIG. 4 and FIG. 5.

As illustrated in FIG. 6, at step S100, the CPU 18 of the server 14 illustrated in FIG. 2 acquires the package information. The CPU 18 also acquires the impediment information at step S102, and acquires the driver information at step S104. Note that all this information is acquired at substantially the same time, and the order of acquisition is not limited to that described herein.

Next, at step S106, the CPU 18 for example determines whether or not the package weighs 3.0 kg or less. In this example, the maximum deliverable package weight of each driver is confirmed based on the driver information.

In cases in which the CPU 18 determines that the package weighs 3.0 kg or less at step S106 (step S106: Y), processing transitions to step S108, whereupon delivery drivers B, E, F, and H are selected from out of delivery drivers A to H.

Next, at step S110, the CPU 18 determines whether or not impediment information is present. In this case, the presence of impediment information is checked for each of the delivery drivers B, E, F, and H based on the driver information.

In cases in which the CPU 18 determines that impediment information is not present at step S110 (step S110: Y), processing transitions to step S112, whereupon the delivery driver E or the delivery driver H is selected from out of the delivery drivers B, E, F and H, and the processing flow is ended.

On the other hand, in cases in which the CPU 18 determines that the package weighs more than 3.0 kg at step S106 (step S106: N), processing transitions to step S114, whereupon the delivery drivers A, C, D, and G are selected from out of the delivery drivers A to H.

Next, at step S116, the CPU 18 determines whether or not impediment information is present. In this case, the presence of impediment information for the delivery drivers A, C, D, G is checked based on the driver information.

In cases in which the CPU 18 determines that impediment information is not present at step S116 (step S116: Y), processing transitions to step S118, whereupon the delivery driver C or the delivery driver G is selected from out of the delivery drivers A, C, D, G, and the processing flow is ended.

On the other hand, in cases in which the CPU 18 determines that impediment information is present at step S110 (step S110: N), processing transitions to step S120, whereupon the delivery driver B or the delivery driver F is selected from out of the delivery drivers B, E, F, H, and the processing flow is ended.

Moreover, in cases in which the CPU 18 determines that impediment information is present at step S116 (step S116: N), processing transitions to step S122, whereupon the delivery driver A or the delivery driver D is selected from out of the delivery drivers A, C, D, G, and the processing flow is ended.

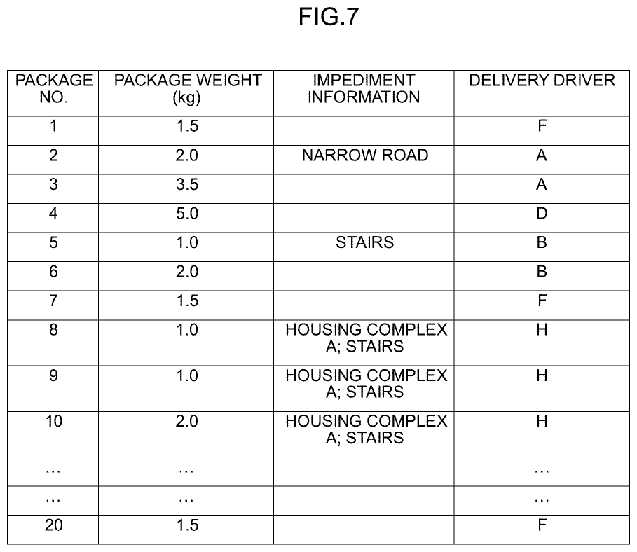

An appropriate delivery driver is selected for each package in the above manner. FIG. 7 illustrates an example of this.

For example, packages 2 and 3 are to be delivered by delivery driver A, packages 5 and 6 are to be delivered by delivery driver B, package 4 is to be delivered by delivery driver D, packages 1, 7, and 20 are to be delivered by delivery driver F, and packages 8, 9, and 10 are to be delivered by delivery driver H.

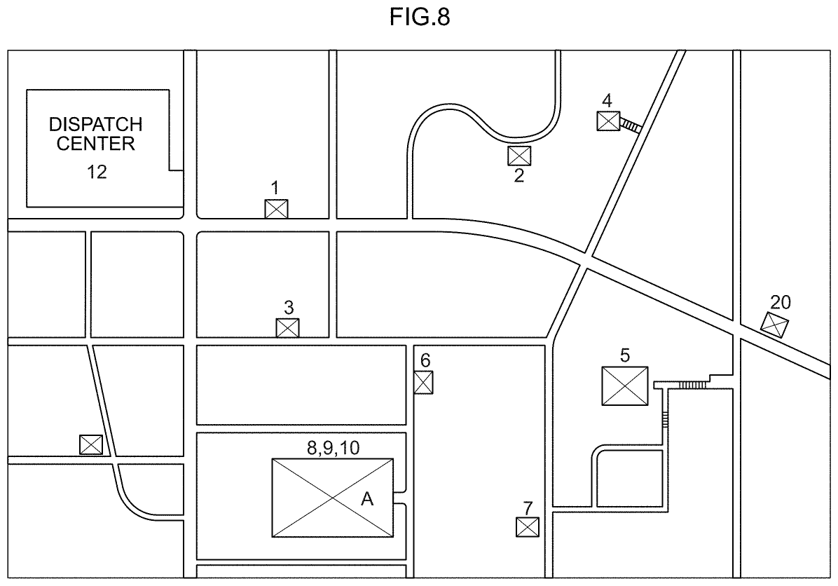

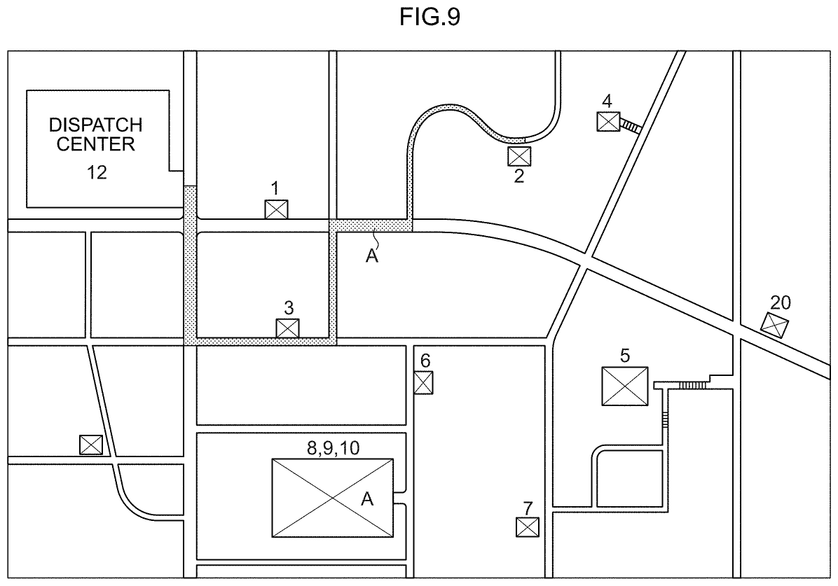

FIG. 8 illustrates a map of a delivery area. The numbers illustrated on this map correspond to package numbers. For example, in the case of delivery driver A, a delivery route A such as that indicated by dotted shading in FIG. 9 is generated by the delivery route generation section 36 in order to deliver packages 2 and 3.

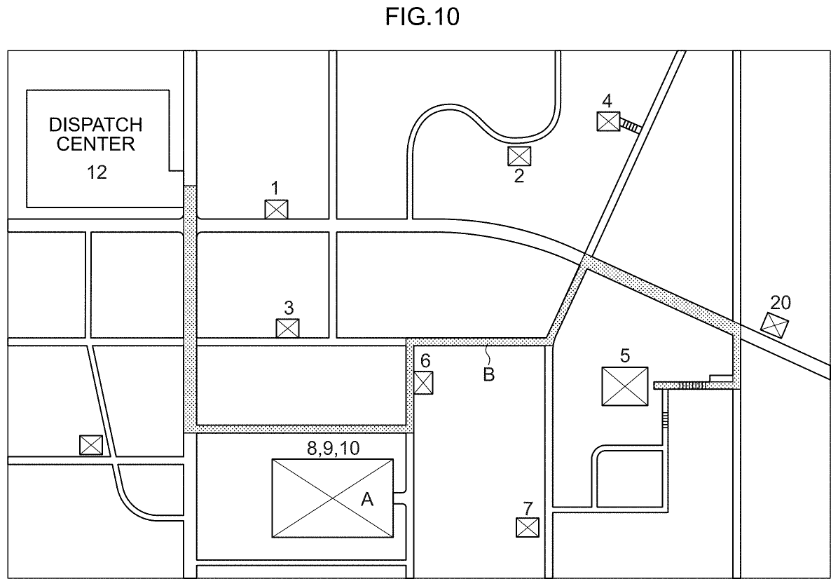

In the case of delivery driver B, a delivery route B such as that indicated by dotted shading in FIG. 10 is generated by the delivery route generation section 36 in order to deliver packages 5 and 6.

The respective delivery routes A and B by which the delivery drivers A and B deliver packages to their delivery destinations are generated by the delivery route generation section 36 in this manner. This enables efficient delivery of packages based on the delivery routes A and B generated by the delivery route generation section 36 without the delivery drivers A and B having to devise the delivery routes A and B themselves. Note that respective delivery routes are also generated for the other delivery drivers C to H in a similar manner to those for the delivery drivers A and B.

As described above, the present exemplary embodiment includes the package information section 30, the driver information section 32, the package selection section 34, and the delivery route generation section 36. Package information (see FIG. 4) indicating the types of packages to be dispatched from the dispatch center 12 is collected in the package information section 30. Driver information (see FIG. 5) indicating the suitability of each of plural delivery drivers for delivery of packages from the dispatch center 12 to their respective delivery destinations is collected in the driver information section 32.

The package selection section 34 selects packages for delivery by each delivery driver based on the package information obtained by the package information section 30 and the driver information obtained by the driver information section 32. The delivery route generation section 36 uses the map information to generate delivery routes for the respective delivery drivers to deliver the packages to their delivery destinations according to the packages selected by the package selection section 34.

Namely, in the present exemplary embodiment, the package selection section 34 selects packages for delivery by each delivery driver based on the package information obtained by the package information section 30 in consideration of the suitability (attributes) of each delivery driver according to the driver information. Thus, the present exemplary embodiment enables the burden experienced by each individual delivery driver to be lightened.

As a general rule, since each delivery driver has different attributes (nationality, gender, age, driving skill, lifting ability, etc.), each individual delivery driver would experience a different burden if allocated a uniform delivery quota. Conversely, setting delivery quotas according to the respective attributes of the delivery drivers enables the load experienced by each individual delivery driver to be evened out. Namely, in the present exemplary embodiment, delivery plans designed based on the respective attributes of the delivery drivers enables the delivery quotas of the respective delivery drivers to be evened out in terms of the burden experienced.

For example, in the present exemplary embodiment, information including the package weight is included in the package information as illustrated in FIG. 4, and information including the maximum package weight deliverable by each delivery driver is included in the driver information as illustrated in FIG. 5. Thus, the package selection section 34 selects packages for delivery by the respective delivery drivers based on the respective package weights.

Note that in a case in which a given delivery driver has a maximum deliverable package weight of 3 kg, this delivery driver is also able to deliver packages weighing 2 kg. However, since a package weighing 5 kg would place a high load on this delivery driver, the delivery driver is exempted from delivering such packages. Namely, in the present exemplary embodiment, the packages for delivery by each delivery driver are selected in consideration of the suitability of each delivery driver.

Furthermore, in the present exemplary embodiment, information regarding unfeasible deliveries that would place a high load on the delivery driver (first unfeasible delivery information) is included in the driver information. For example, in the case of a delivery driver having a maximum deliverable package weight of 3 kg as described above, it would be difficult to deliver a package weighing 5 kg, and this would place a high load on the delivery driver. Thus, this delivery driver is exempted from deliveries of packages weighing over 3 kg, and this fact is included in their unfeasible delivery information.

The package selection section eliminates any packages that correspond to this unfeasible delivery information from being selected for a delivery driver with such unfeasible delivery information. Namely, the delivery driver mentioned above would not be expected to deliver excessively heavy packages weighing over 3 kg. Thus, in the present exemplary embodiment, a delivery driver is not required to deliver excessively heavy packages in cases in which this would place a high load on the delivery driver, thereby enabling the load on this delivery driver to be lightened.

Note that although the present exemplary embodiment describes a case in which delivery drivers are selected based on the package weights included in the package information, different delivery driver selection criteria are also stipulated with respect to other package information, and so there is no limitation thereto. For example, a delivery driver may be selected according to the package content (ambient temperature, frozen, or chilled) as included in the package information. In the case of a chilled package, faster package delivery is preferable, and so a delivery driver with delivery experience and excellent driving skills may be selected.

Moreover, in the present exemplary embodiment, the driver information includes information (second unfeasible delivery information) pertaining to the impediment information as information regarding deliveries that would place a high load on the delivery driver and delivery is unable to be performed. For example, as described previously, stairs, narrow roads, and mountain roads are examples of impediment information, and driving on a delivery route including such impediments would place a high load on a delivery driver who is unable to make or would not be comfortable making deliveries involving stairs, narrow roads, mountain roads, or the like. Thus, information indicating stairs, narrow roads, mountain roads, or the like is included as the impediment information in the unfeasible delivery information.

The package selection section then eliminates any packages corresponding to this unfeasible delivery information from being selected for the delivery driver with this unfeasible delivery information. Namely, such a delivery driver would not be expected to deliver packages to delivery destinations on a delivery route for which they are exempt from or would not be comfortable making deliveries, for example a delivery route involving stairs, narrow roads, mountain roads, or the like.

Thus, in the present exemplary embodiment, a delivery driver does not have to deliver packages using delivery routes that would place a high load on this delivery driver, thereby enabling the load on the delivery driver to be lightened.

In the present exemplary embodiment, the load on delivery drivers is lightened in the above manner. The delivery industry has been suffering from increasingly severe staff shortages in recent times. Evening out the load on the individual delivery drivers through the use of delivery plans based on the attributes of the delivery drivers enables delivery drivers to be secured and retained, and also helps to promote diversity.

Implementing the delivery system that sets delivery quotas corresponding to the driver information of the delivery drivers in the above manner further enables, for example, appropriate delivery driver allocation for all-female accommodation or areas with a large number of foreign residents, thereby enabling responsivity to customer requirements.

Note that the processing executed by the CPU reading and executing software (a program) in the above exemplary embodiment may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC).

The processing of the above exemplary embodiment may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Although the program for the processing of the above exemplary embodiment is in a format pre-stored (installed) in the ROM or storage, there is no limitation thereto. The program may be provided in a format recorded on a recording medium such as compact disc read only memory (CD-ROM), digital versatile disc read only memory (DVD-ROM), or universal serial bus (USB) memory. Alternatively, the program may be provided in a format downloadable from an external device over a network.

What is claimed is:

1. A delivery system comprising:
a storage configured to store package information indicating respective types of a plurality of packages for delivery from a dispatch base, and driver information indicating suitability of each of a plurality of delivery drivers to delivery of the respective packages from the dispatch base to a delivery destination; and
a processor configured to select a package for delivery by a delivery driver based on the package information and the driver information, and generate a delivery route for a delivery driver to deliver the selected package to the corresponding delivery destination.

2. The delivery system of claim 1, wherein:
the package information is information including a package weight; and
the driver information is information including a maximum deliverable package weight of each of the delivery drivers.

3. The delivery system of claim 1, wherein in cases in which the driver information includes first unfeasible delivery information pertaining to the package information as unfeasible delivery information regarding a delivery that would place a high load on the corresponding delivery driver, the processor eliminates any package corresponding to the first unfeasible delivery information from being selected for the delivery driver with the first unfeasible delivery information.

4. The delivery system of claim 2, wherein in cases in which the driver information includes first unfeasible delivery information pertaining to the package information as unfeasible delivery information regarding a delivery that would place a high load on the corresponding delivery driver, the processor eliminates any package corresponding to the first unfeasible delivery information from being selected for the delivery driver with the first unfeasible delivery information.

5. The delivery system of claim 1, wherein the delivery route includes impediment information regarding an impediment to package delivery.

6. The delivery system of claim 2, wherein the delivery route includes impediment information regarding an impediment to package delivery.

7. The delivery system of claim 3, wherein the delivery route includes impediment information regarding an impediment to package delivery.

8. The delivery system of claim 4, wherein the delivery route includes impediment information regarding an impediment to package delivery.

9. The delivery system of claim 5, wherein in cases in which the driver information includes second unfeasible delivery information pertaining to the impediment information as unfeasible delivery information regarding a delivery that would place a high load on the corresponding delivery driver, the processor eliminates any package corresponding to the second unfeasible delivery information from being selected for the delivery driver with the second unfeasible delivery information.

10. The delivery system of claim 6, wherein in cases in which the driver information includes second unfeasible delivery information pertaining to the impediment information as unfeasible delivery information regarding a delivery that would place a high load on the corresponding delivery driver, the processor eliminates any package corresponding to the second unfeasible delivery information from being selected for the delivery driver with the second unfeasible delivery information.

11. The delivery system of claim 7, wherein in cases in which the driver information includes second unfeasible delivery information pertaining to the impediment information as unfeasible delivery information regarding a delivery that would place a high load on the corresponding delivery driver, the processor eliminates any package corresponding to the second unfeasible delivery information from being selected for the delivery driver with the second unfeasible delivery information.

12. The delivery system of claim 8, wherein in cases in which the driver information includes second unfeasible delivery information pertaining to the impediment information as unfeasible delivery information regarding a delivery that would place a high load on the corresponding delivery driver, the processor eliminates any package corresponding to the second unfeasible delivery information from being selected for the delivery driver with the second unfeasible delivery information.
